(19) United States
(12) Patent Application Publication
(10) Pub. No.: US 2024/0203158 A1
(43) Pub. Date: Jun. 20, 2024

(54) METHOD AND APPARATUS FOR DETECTING FACE ATTRIBUTE, STORAGE MEDIUM AND ELECTRONIC DEVICE

(71) Applicant: BOE Technology Group Co., Ltd., Beijing (CN)

(72) Inventors: Tingting WANG, Beijing (CN); Jingtao XU, Beijing (CN)

(73) Assignee: BOE Technology Group Co., Ltd., Beijing (CN)

(21) Appl. No.: 17/772,537

(22) PCT Filed: Apr. 1, 2021
(86) PCT No.: PCT/CN2021/084803

§ 371 Date: Apr. 28, 2022

(51) Int. Cl. G06V 40/16; G06F 18/40; G06T 3/40; G06T 7/33; G06T 7/73

(52) U.S. Cl. CPC G06V 40/165; G06F 18/40; G06T 3/40; G06T 7/337; G06T 7/73; G06V 40/169; G06T 2207/30201

(57) ABSTRACT

A method and apparatus for detecting a face attribute, a computer-readable storage medium and an electronic device are provided. The method includes: extracting a face image from a candidate image; acquiring a target image block corresponding to at least one target part of the face image; and obtaining, for one of the at least one target part, target attribute information by performing attribute detection on the target image block corresponding to the target part using a pre-trained attribute detection model corresponding to the target part.

### CROSS-REFERENCE TO RELATED APPLICATIONS

The present disclosure is a national phase entry under 35 U.S.C. § 371 of International Application No. PCT/CN2021/084803, filed on Apr. 1, 2021, the entire contents of which are hereby incorporated by reference in its entirety.

### TECHNICAL FIELD

The present disclosure relates to the field of image processing technologies, and in particular, to a method and apparatus for detecting a face attribute, a computer-readable storage medium and an electronic device.

### BACKGROUND

Face-related image processing technologies are a very important research direction in computer vision tasks. The face, as an important biological feature of human beings, is used in many applications in the field of human-computer interaction.

The face attribute recognition in the related art uses a neural network model to obtain a plurality of attribute results for each part in a human face, which uses a large model, takes longer to compute, and has poor accuracy.

It should be rioted that, the information disclosed in the BACKGROUND section above is only for enhancing the understanding of the background of the present disclosure, and thus may include information that does not constitute prior art known to those skilled in the art.

### SUMMARY

According to a first aspect of the present disclosure, there is provided a method for detecting a face attribute, including: extracting a face image from a candidate image; acquiring a target image block corresponding to at least one target part of the face image; and obtaining, for one of the at least one target part, target attribute information by performing attribute detection on the target image block corresponding to the target part using a pre-trained attribute detection model corresponding to the target part.

According to a second aspect of the present disclosure, there is provided a non-transitory computer-readable medium on which a computer program is stored, and the computer program, when executed by a processor, implements the above-described method.

According to a third aspect of the present disclosure, there is provided an electronic device, including: a processor; and a memory for storing one or more programs that, when executed by one or more processors, cause the one or more processors to implement the above-described method.

It should be understood that both the foregoing general description and the following detailed description are exemplary and explanatory only and not for limiting the present disclosure.

### BRIEF DESCRIPTION OF THE ACCOMPANYING DRAWINGS

Accompanying drawings herein, which are incorporated in the specification and constitute a part of the specification, illustrate embodiments conforming to the present disclosure, and are used to explain the principles of the present disclosure together with the specification. It is apparent that the accompanying drawings in the following description only show some of the embodiments of the present disclosure, and other accompanying drawings can also be obtained according to these accompanying drawings without any creative efforts by those skilled in the art.

FIG. 1 illustrates a schematic diagram of an exemplary system architecture applicable to the embodiments of the present disclosure.

FIG. 2 illustrates a schematic diagram of an electronic device applicable to the embodiments of the present disclosure.

FIG. 3 illustrates a flowchart of a method for detecting a face attribute in some exemplary embodiments of the present disclosure.

FIG. 4 illustrates a schematic diagram of an image to be recognized in some exemplary embodiments of the present disclosure.

FIG. 5 illustrates an extracted face image in some exemplary embodiments of the present disclosure.

FIG. 6 illustrates a face image after alignment in some exemplary embodiments of the present disclosure,

FIG. 7 illustrates a schematic diagram of the selection of a target image block from a face image in some exemplary embodiments of the present disclosure.

FIG. 8 illustrates a flowchart of acquisition of a pre-trained attribute detection model in some exemplary embodiments of the present disclosure.

FIG. 9 illustrates a flowchart of acquisition of attribute information of an eye part and a mouth corner part in some exemplary embodiments of the present disclosure.

FIG. 10 illustrates a structural schematic diagram of an attribute detection model in some exemplary embodiments of the present disclosure.

FIG. 11 illustrates a schematic diagram of a composition of an apparatus for detecting a face attribute in some exemplary embodiments of the present disclosure.

### DETAILED DESCRIPTION

Exemplary embodiments will now be described more fully with reference to the accompanying drawings. However, the exemplary embodiments may be implemented in various forms and should not be construed as limited to the examples set forth herein; rather, these embodiments are provided so that the present disclosure will be more comprehensive and complete, and will fully convey the concept of exemplary embodiments to those skilled in the art. The described features, structures, or characteristics may be combined in any suitable manner in one or more embodiments.

Furthermore, the accompanying drawings are merely schematic illustrations of the present disclosure and are not necessarily drawn to scale. The same reference numerals in the accompanying drawings denote the same or similar parts, and thus their repetitive description will be omitted. Some of the block diagrams shown in the accompanying drawings are functional entities and do not necessarily correspond to physically or logically separate entities. These functional entities may be implemented in a software form or in one or more hardware modules or integrated circuits, or implemented in different networks and/or processor devices and/or microcontroller devices.

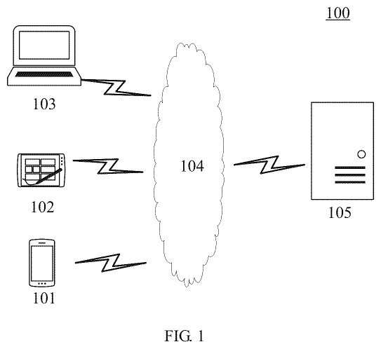

FIG. 1 illustrates a schematic diagram of system architecture of an exemplary application environment applicable to a method and apparatus for detecting a face attribute of some embodiments of the present disclosure.

As shown in FIG. 1, the system architecture 100 may include one or more of terminal devices 101, 102, 103, a network 104, and a server 105. The network 104 serves as a medium for providing communication links between the terminal devices 101, 102, 103 and the server 105. The network 104 may include various connection types, for example, wired, wireless communication links, or fiber optic cables, and the like. The terminal devices 101, 102, 103 may be various electronic devices with image processing function, including but not limited to desktop computers, portable computers, smart phones, tablet computers, and the like. It should be understood that, the number of terminal devices, networks, and servers in FIG. 1 is merely illustrative. There may be any number of terminal devices, networks, and servers depending on implementation needs. For example, the server 105 may be a server cluster comprised of multiple servers, and the like.

The method for detecting the face attribute provided by the embodiments of the present disclosure is generally executed by the terminal devices 101, 102, and 103, and accordingly, the apparatus for detecting the face attribute is generally disposed in the terminal devices 101, 102, and 103. However, it is easily understood by those skilled in the art that the method for detecting the face attribute provided by the embodiments of the present disclosure may also be executed by the server 105, and accordingly, the method for detecting the face attribute may also be disposed in the server 105, which is not particularly limited in the exemplary embodiments. For example, in one exemplary embodiment, a user may capture a candidate image (an image to be processed) through the terminal devices 101, 102, and 103, and then upload the candidate image to the server 105, and after the server generates a depth image by the method for generating a depth image provided by the embodiments of the present disclosure, the depth image is transmitted to the terminal devices 101, 102, 103, and the like.

The exemplary embodiments of the present disclosure provide an electronic device for implementing a method for detecting a face attribute, which may be the terminal devices 101, 102, 103 or the server 105 in FIG. 1. The electronic device includes at least a processor and a memory for storing executable instructions of the processor, the processor is configured to perform the method for detecting the face attribute via execution of the executable instructions.

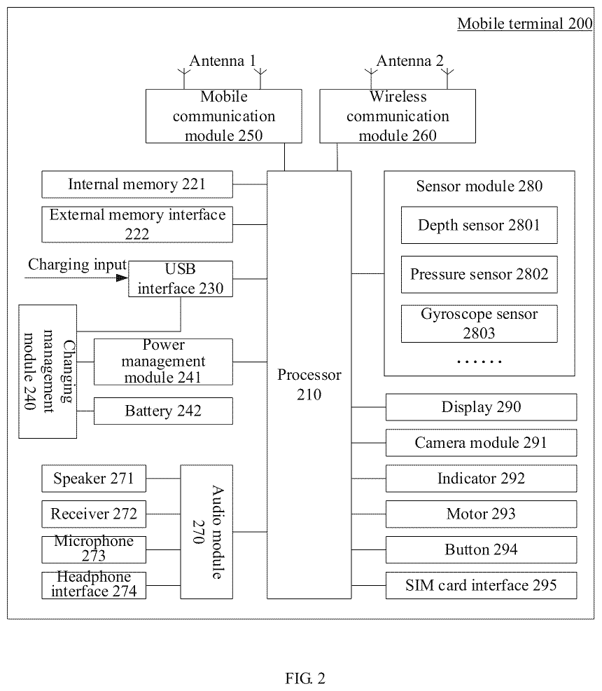

The configuration of the electronic device is exemplarily described below by taking the mobile terminal 200 in FIG. 2 as an example. It should be appreciated by those skilled in the art that the configuration in FIG. 2 can also be applied to fixed type of devices, in addition to components specifically for mobile purposes. In some other embodiments, the mobile terminal 200 may include more or fewer components than illustrated, or combine certain components, or split certain components, or arrange different components. The illustrated components may be implemented in hardware, software, or a combination of software and hardware. An interface connection relationship between various components is only schematically illustrated and does not constitute a structural limitation of the mobile terminal 200. In some other embodiments, the mobile terminal 200 may also adopt an interface connection way different from that of FIG. 2, or a combination of various interface connection ways.

As shown in FIG. 2, the mobile terminal 200 may specifically include: a processor 210, an internal memory 221, an external memory interface 222, a Universal Serial Bus (USB) interface 230, a charging management module 240, a power management module 241, a battery 242, an antenna 1, an antenna 2, a mobile communication module 250, a wireless communication module 260, an audio module 270, a speaker 271, a receiver 272, a microphone 273, a headphone interface 274, a sensor module 280, a display 290, a camera module 291, an indicator 292, a motor 293, a button 294, and a subscriber identification module (SIM) card interface 295, and the like. The sensor module 280 may include a depth sensor 2801, a pressure sensor 2802, a gyroscope sensor 2803, and the like.

The processor 210 may include one or more processing units, for example, the processor 210 may include an application processor (AP), a modem processor, and a Graphics Processing Unit (GPU), an Image Signal Processor (ISP), a controller, a video codec, a Digital Signal Processor (DSP), a baseband processor, and/or a neural network processor (e.g., Neural-Network Processing Unit, NPU), and the like. Among them, the different processing units may be independent devices, or may be integrated in one or more processors.

The NPU is a Neural-Network (NN) computing processor. By referring to a structure of a biological neural network, for example, referring to a mode of transmission between neurons in a human brain, the NPU quickly processes input information, and may further perform self-learning continuously. By using the NPU, an application such as intelligent cognition of the mobile terminal 200 may be implemented, for example: image recognition, face recognition, voice recognition, text understanding and the like.

A memory is disposed in the processor 210. The memory may store instructions for implementing six modular functions including a detection instruction, a connection instruction, an information management instruction, an analysis instruction, a data transmission instruction, and a notification instruction, and their execution is controlled by processor 210.

The charge management module 240 is used for receiving a charging input from a charger. The power management module 241 is used for connecting the battery 242, the charging management module 240 and the processor 210. The power management module 241 receives the input of the battery 242 and/or the charging management module 240, and supplies power to the processor 210, the internal memory 221, the display 290, the camera module 291, the wireless communication module 260, and the like.

A wireless communication function of the mobile terminal 200 may be implemented by using the antenna 1, the antenna 2, the mobile communication module 250, the wireless communication module 260, the modern processor, the baseband processor, and the like. The antenna 1 and the antenna 2 are used for sending and receiving an electromagnetic wave signal. The mobile communication module 250 may provide a solution including wireless communication of 2G/3G/4G/5G etc. applied on the mobile terminal 200. The modem processor may include a modulator and a demodulator. The wireless communication module 260 may provide a wireless communications solution applied to the mobile terminal 200 and that includes Wireless Local Area Networks (WLANs) (for example, a Wireless Fidelity (Wi-Fi) Network), Bluetooth (BT), and the like. In some embodiments, the antenna 1 of the mobile terminal 200 is coupled to the mobile communication module 250 and the antenna 2 is coupled to the wireless communication module 260, so that the mobile terminal 200 may communicate with networks and other devices using wireless communication technologies.

The mobile terminal 200 implements a display function through the GPU, the display 290, the application processor, and the like. The GPU is a microprocessor for image processing, and is connected to the display 290 and the application processor. The GPU is used to perform mathematical and geometric calculations for graphics rendering. The processor 210 may include one or more GPUs that execute program instructions to generate or change display information.

The mobile terminal 200 may implement a photographing function using the ISP, the camera module 291, the video codec, the GPU, the display 290, the application processor, and the like. The ISP is used to process data fed back by the camera module 291. The camera module 291 is used to capture still images or videos. The digital signal processor is used to process digital signals, and may process another digital signal in addition to a digital image signal. The video codec is used to compress or decompress a digital video, and the mobile terminal 200 may support one or more types of video codecs.

The external memory interface 222 may be used to connect an external memory card, for example, a Micro SID card, so as to expand the storage capacity of the mobile terminal 200. The external memory card communicates with the processor 210 through the external memory interface 222 to realize the data storage function. For example, the external memory card saves music, video and other files.

The internal memory 221 may be used to store computer executable program code, and the executable program code includes an instruction. The internal memory 221 may include a program storage area and a data storage area. Among them, the storage program area may store an operating system, an application program required by at least one function (such as a sound playback function, an image playback function, etc.), and the like. The data storage area may store data (such as audio data, phone book, etc.) created when the mobile terminal 200 is used. In addition, the internal memory 221 may include a high-speed random access memory, and may also include a non-volatile memory, for example, at least one magnetic disk storage device, a flash storage device, a universal flash storage (UFS), and the like. The processor 210 executes various functional applications and data processing of the mobile terminal 200 by executing instructions stored in the internal memory 221 and/or instructions stored in a memory provided in the processor.

The mobile terminal 200 can implement audio functions, such as music playback, recording, etc., through the audio module 270, the speaker 271, the receiver 272, the microphone 273, headphone interface 274, and the application processor, and the like.

The depth sensor 2801 is used to acquire depth information of a scene. In some embodiments, the depth sensor may be disposed in the camera module 291.

The pressure sensor 2802 is used to sense a pressure signal, and may convert the pressure signal into an electrical signal. In some embodiments, the pressure sensor 2802 may be disposed on the display 290. There are many types of pressure sensors 2802, such as a resistive pressure sensor, an inductive pressure sensor, a capacitive pressure sensor, and the like.

The gyroscope sensor 2803 may be used to determine a moving posture of the mobile terminal 200. In some embodiments, an angular velocity of the mobile terminal 200 about three axes (i.e., axes x, y, and z) may be determined by the gyroscope sensor 2803. The gyroscope sensor 2803 may be used to an anti-shake photograph, a navigation scenario, a somatic game scenario, and the like.

Furthermore, sensors with other functions may also be disposed in the sensor module 280 according to actual needs, for example, an air pressure sensor, a magnetic sensor, an acceleration sensor, a distance sensor, an optical proximity sensor, a fingerprint sensor, a temperature sensor, a touch sensor, an ambient light sensor, a bone conduction sensor, and the like may be disposed in the sensor module 280 according to actual needs.

Other devices for providing auxiliary functions may also be included in mobile terminal 200. For example, the button 294 includes a power-on key, a volume key, and the like, and a key signal input related to a user setting and function control of the mobile terminal 200 may be generated via user key input. As another example, the devices for providing auxiliary functions may include an indicator 292, a motor 293, a SIM card interface 295, and the like.

In the related art, the face detection technology may be applied in many scenarios, such as video monitoring, product recommendation, human-computer interaction, market analysis, user profile, age progression, and the like. In a video monitoring scenario, retrieval may be performed on the detected human face from description after tagging the face attributes, such as finding people wearing glasses and/or with a beard. In the related art for face attribute detection, multiple attributes are detected by a single model, which is larger, with slower detection speed and lower accuracy.

The method and apparatus for detecting the face attribute of the exemplary embodiments of the present disclosure will be described below in detail,

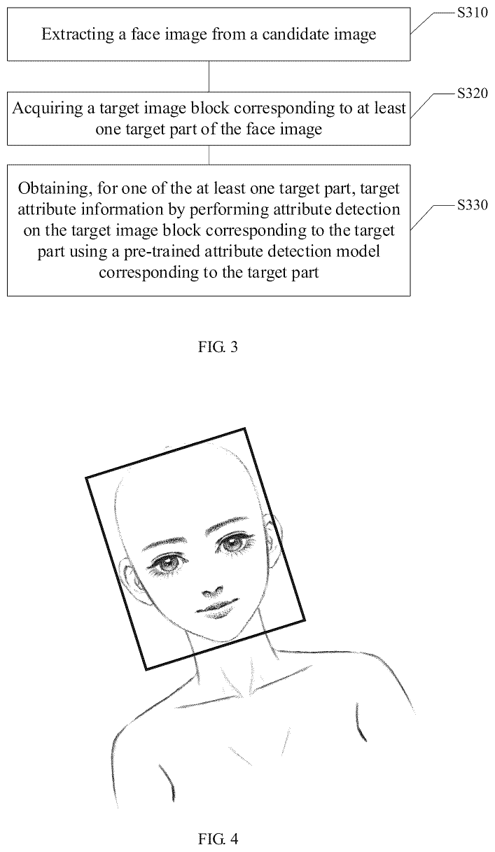

FIG. 3 illustrates a flow of the method for detecting the face attribute according to some exemplary embodiments. The method includes the following steps S310 to S330.

At step S310, a face image is extracted from a candidate image.

At step S320, a target image block corresponding to at least one target part of the face image is acquired.

At step S330, for one of the at least one target part, target attribute information is obtained by performing attribute detection on the target image block corresponding to the target part using a pre-trained attribute detection model corresponding to the target part.

Compared with the prior art, the face image is first segmented to obtain target parts, and the target image blocks of different target parts are recognized using different models. On one hand, purposeful detection of the attributes of the target part that need to be detected can avoid recognition of the face attributes which are not needed, and thus improving the detection speed; on the other hand, one attribute detection model is set for each kind of attribute information of each target part, so that the detection accuracy can be improved; on yet another hand, multiple attribute detection models can be used simultaneously and the multiple attribute detection models are small and run fast, and thus improving the face attribute detection speed.

At step S310, the face image is extracted from the candidate image.

In one exemplary embodiment of the present disclosure, as shown in FIG. 4, the candidate image may be first acquired, where the candidate image includes a face image of at least one person, and then the face image may be extracted from the acquired image. There are various ways to extract the face image, for example, the face image may be extracted using a face image extraction model, or the face image may be extracted from the candidate image by determining the position information of a human face in the candidate image using a machine learning library (e.g., Dlib). Dlib is a machine learning library programmed by C++ and includes a lot of common algorithms for machine learning. If the candidate image contains a plurality of human faces, a plurality of face images with different sizes can be obtained after the human faces in the candidate image are extracted. The face image can also be extracted by methods such as edge detection, etc., which are not specifically limited in this exemplary embodiment.

In this exemplary embodiment, the candidate image may also include an incomplete face image, for example, a side face, or half of the face image, and the like. The detected incomplete face image may be deleted. Alternatively, the detected incomplete face image may be reserved, and when training the attribute detection model, the incomplete image may be added to the sample dataset, so that the pre-trained attribute detection model may perform attribute detection on the incomplete face image.

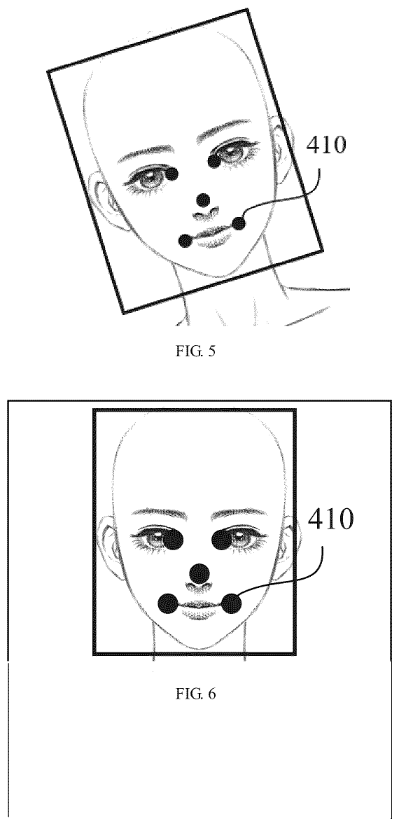

In this exemplary embodiment, as shown in FIGS. 5 and 6, after extracting the face image, alignment may be performed on the face image. Specifically, a plurality of reference key points 410 in the face image may be first acquired, the number of the reference key points 410 may be five, they may be respectively located at two eyeball parts, a nose tip part, and two mouth corners of a person in the face image. In a coordinate system set for the above-mentioned face image, initial coordinates of each reference key point 410 may be first acquired, and then target coordinates of each reference key point 410 may be acquired. A transformation matrix may be acquired according to the target coordinates and the initial coordinates, and then transformation and alignment may be performed on the face image using the transformation matrix.

It should be noted that, the number of the reference key points 410 may also be six, seven or more, for example, 68, 81, 106, 150, etc., and may also be customized according to the requirement of the user, which is not specifically limited in this exemplary embodiment.

At step S320, the target image block 710 corresponding to at least one target part of the face image is acquired.

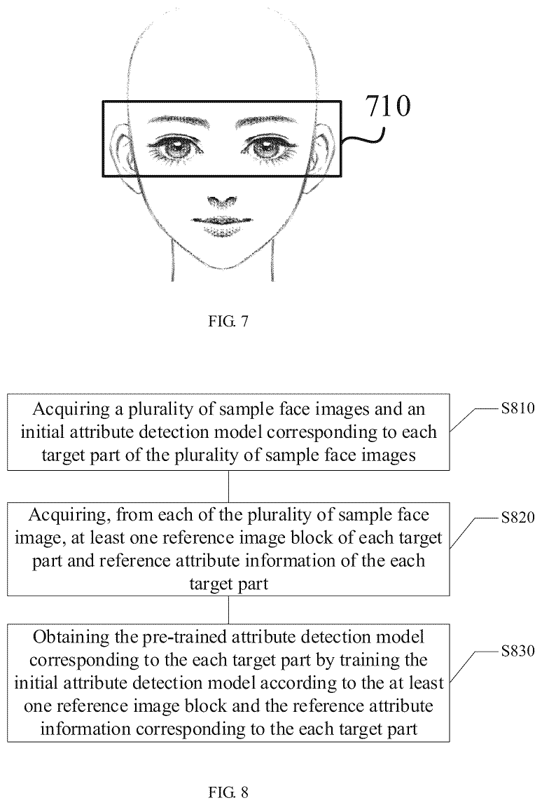

In one exemplary embodiment of the present disclosure, as shown in FIG. 7, after acquiring the face image, an image block corresponding to at least one target part in the face image may be acquired, where the target part may include one kind of the following parts: eyes, nose, mouth, left cheek, right cheek, or forehead, etc.

The target image block 710 may be a smallest area of the face image capable of containing the target part, or may be a rectangular area capable of containing the target part and having a preset length and a preset width, or may be customized according to a user, which is not specifically limited in this exemplary embodiment.

In this exemplary embodiment, there may be multiple target image blocks in a same part, and during extraction, all the multiple target image blocks 710 may be obtained by selecting an area on the human face image and copying the selected area, so that each target part in each target image block 710 is complete. Compared with the direct cropping of the face image, the problem of low accuracy of face attribute detection caused by incomplete extraction of the target part is avoided, and the accuracy of the face attribute detection is improved.

In this exemplary embodiment, a target part extraction model may be used for extracting the target block. Specifically, a plurality of target key points in the face image may be determined, where the number of the target key points may be five, that is, the same as the number of the reference key points 410, the number of the target key points may also be six, seven or more, for example, 68, 81, 106, 150, etc., and may also be customized according to the requirement of the user, which is not specifically limited in this exemplary embodiment. In some embodiments, the target key points may be selected from the reference key points.

After determining the target key points, each target part in the face image is determined according to the position and coordinates of the key points, and after determining each target part, a smallest area of the face image capable of containing the target part may be taken as one target image block 710, or a rectangular area capable of containing the target part and having a preset length and a preset width may be taken as one target image block 710, or the target image block 710 may also be customized according to the user, which is not specifically limited in this exemplary embodiment.

The above-mentioned target part extraction model is obtained by training. In this exemplary embodiment, the initial model may be a Convolutional Neural Network (CNN) model, an object detection Convolutional Neural Network (faster-RCNN) model, a Recurrent Neural Network (RNN) model, a Generative Adversarial Network (GAN) model, but is not limited thereto, and other neural network models known to those skilled in the art may also be employed. It is not specifically limited in this exemplary embodiment.

The target part extraction model is mainly a neural network model based on deep learning. For example, the target part extraction model may be based on a feedforward neural network. The feedforward neural network may be implemented as an acyclic graph, where nodes are arranged in layers. Typically a feedforward network topology includes an input layer and an output layer, and the input layer and the output layer are separated by at least one hidden laver. The hidden layer transforms the input received by the input layer into a useful representation for generating output in the output layer. Network nodes are all connected to nodes in adjacent layers via edges, but there are no edges between nodes in each layer. The data received at the nodes of the input layer of the feedforward network is propagated (i.e., “feedforward”) to the nodes of the output layer via an activation function. The activation function is used to calculate the state of the nodes of each successive layer in the network based on coefficients (“weights”) respectively associated with each of the edges connecting these layers. The output of the target part extraction model may take various forms, which are not limited by the present disclosure. The target part extraction model may also include other neural network models, for example, a Convolutional Neural Network (CNN) model, a Recurrent Neural Network (RNN) model, a Generative Adversarial Network (CAN) model, but is not limited thereto, and other neural network models known to those skilled in the art may also be employed.

The training of the target part extraction model with the sample data may include the following steps: selecting a network topology; using a group of training data representing network modeled problems; and adjusting a weight until all instances of the network model for the training dataset appear to have minimal error. For example, during a supervised learning training process for neural networks, an output produced by the network in response to an input representing the instance in the training dataset is compared with the “correct” marked output for that instance; calculating an error signal representing a difference between the output and the marked output; and adjusting weights associated with the connections to minimize the error when the error signal is propagated backward through the layers of the network. The model when the error of each output generated from the instance of the training dataset is minimized is defined as a target part extraction model.

In another exemplary embodiment, when extracting the target image block 710, the face image may be first adjusted to a size of a preset size, where the preset size may be 256*256, 128*128, and the like, or may be customized according to a user requirement, which is not specifically limited in this exemplary embodiment.

After the face image is adjusted to the preset size, the vertex coordinates of the target image block 710 corresponding to each target part may be set first, since the image is aligned and adjusted to the same size, and then the corresponding target image block 710 may be acquired from the face image according to the vertex coordinates. In this case, the size of the target image block 710 may be 64*64, or may be customized according to a user requirement, which is not specifically limited in this exemplary embodiment.

At step S330, for one of the at least one target part, the target attribute information is obtained by performing attribute detection on the target image block corresponding to the target part using the pre-trained attribute detection model corresponding to the target part.

In one exemplary embodiment of the present disclosure, as shown in FIG. 8, the method for detecting the face attribute may further include the following steps.

At step S810, a plurality of sample face images and an initial attribute detection model corresponding to each target part of the plurality of sample face images are acquired.

At step S820, at least one reference image block of each target part and reference attribute information of the each target part are acquired from each one of the plurality of sample face images.

At step S830, the pre-trained attribute detection model corresponding to the each target part is obtained by training the initial attribute detection model according to the at least one reference image block and the reference attribute information corresponding to the each target part.

The above steps are explained in detail below.

At step S810, the plurality of sample face images and the initial attribute detection model corresponding to each target part of the plurality of sample face images are acquired.

In one exemplary embodiment of the present disclosure, first, a plurality of sample face images and an initial attribute detection model corresponding to each target part, for example, an initial attribute detection model corresponding to an eye part, an initial attribute detection model corresponding to a nose part, and the like, are obtained, where the face image may include only a complete face image or an incomplete face image, which is not specifically limited in this exemplary embodiment.

At step S820, the at least one reference image block of each target part and the reference attribute information of the each target part are acquired from each one of the plurality of sample face images.

In one exemplary embodiment of the present disclosure, at least one reference image block may be acquired in each sample face image for each of the target parts, and the size of the reference image block corresponding to each of the target parts may be different. For example, the multiple reference image blocks of an eye part are acquired from the same sample face image, which may increase the number of samples for training the model, and thereby improving the accuracy of the pre-trained attribute detection model.

It is also necessary to acquire attribute information corresponding to the reference image block when the reference image block has been acquired, and the reference image block and the attribute information corresponding to each reference image block are used as training samples for training the initial attribute detection model.

At step S830, the pre-trained attribute detection model corresponding to the each target part is obtained by training the initial attribute detection model according to the at least one reference image block and the reference attribute information corresponding to the each target part.

In one exemplary embodiment of the present disclosure, the reference image block and the corresponding attribute information are used as training sample to train the initial attribute detection model to obtain a pre-trained attribute detection model corresponding to each target part.

The training of the initial attribute detection model with the sample data may include the following steps: selecting a network topology; using a group of training data representing network modeled problems; and adjusting a weight until all instances of the network model for the training dataset appear to have minimal error. For example, during a supervised learning training process for neural networks, an output produced by the network in response to an input representing the instance in the training dataset is compared with the “correct” marked output for that instance; calculating an error signal representing a difference between the output and the marked output; and adjusting weights associated with the connections to minimize the error when the error signal is propagated backward through the layers of the network. The model when the error of each output generated from the instance of the training dataset is minimized is defined as a pre-trained attribute detection model.

In one exemplary embodiment of the present disclosure, after the pre-trained attribute detection model is obtained, the pre-trained attribute detection model corresponding to the target part is used to perform attribute detection on the target image block corresponding to the target part to obtain target attribute information. The target attribute information may include only one piece of attribute information of the target part, or may include all target attribute information of the target part.

In this exemplary embodiment, each target image block may include multiple pieces of attribute information, and one attribute detection model may be set for each piece of attribute information. For example, the attribute information of the eye part may include single/double eyelid and presence/absence of glasses, and in this case, two attribute detection models may be set for the eye part to detect whether it is single or double eyelids and whether glasses are worn or not, respectively.

In this exemplary embodiment, for part of the attribute information, due to a gender feature, the gender may be determined first according to the face image, and then it is determined whether further detection is required or not according to the gender. Specifically, when detecting whether beard exists, the gender may first be detected. If it is female, it is determined directly that there is no beard without further detection using the attribute detection model, which can save calculation resources.

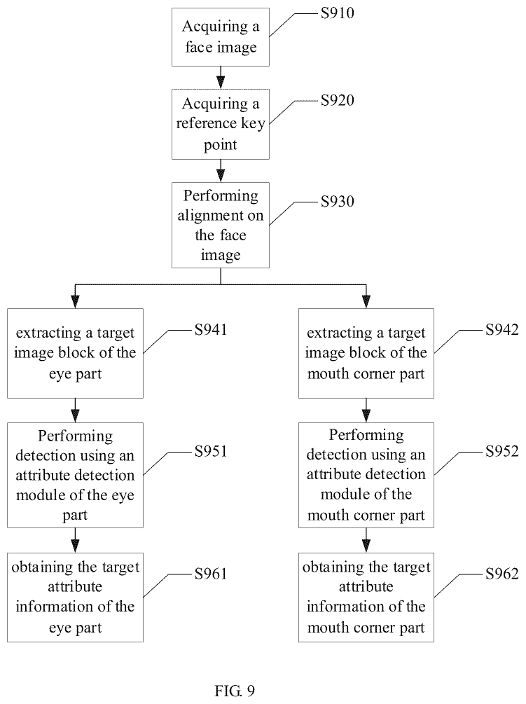

In this exemplary embodiment, the method for detecting the attribute information is described by taking the target parts including the eyes and the mouth corners as an example. As shown in FIG. 9, step S910, acquiring a face image, may be performed first, i.e., the above-described extracting the face image from the candidate image, then step S920, acquiring a reference key point may be performed, and step S930, performing alignment on the face image, e.g., determining the initial coordinates of the reference key point in the face image and the target coordinates of the reference key point to perform alignment on the face image, may be performed, and then step S941, extracting a target image block of the eye part, may be performed: step S951, performing detection on the eye part using an attribute detection model, may be performed, and step S961, obtaining the target attribute information of the eye part, may be performed. Specifically, after acquiring the target image block of the eye part, the target image block is input to the attribute detection model of the eye part to obtain the target attribute information of the eye part. The following steps may be further performed: step S942, extracting a target image block of the mouth corner part; step S952, performing detection on the mouth corner pail using an attribute detection model; and step S962, obtaining target attribute information of the mouth corner part. Specifically, after acquiring the target image block of the mouth corner part, the target image block is input to the attribute detection model of the mouth corner part to obtain the target attribute information of the mouth corner part.

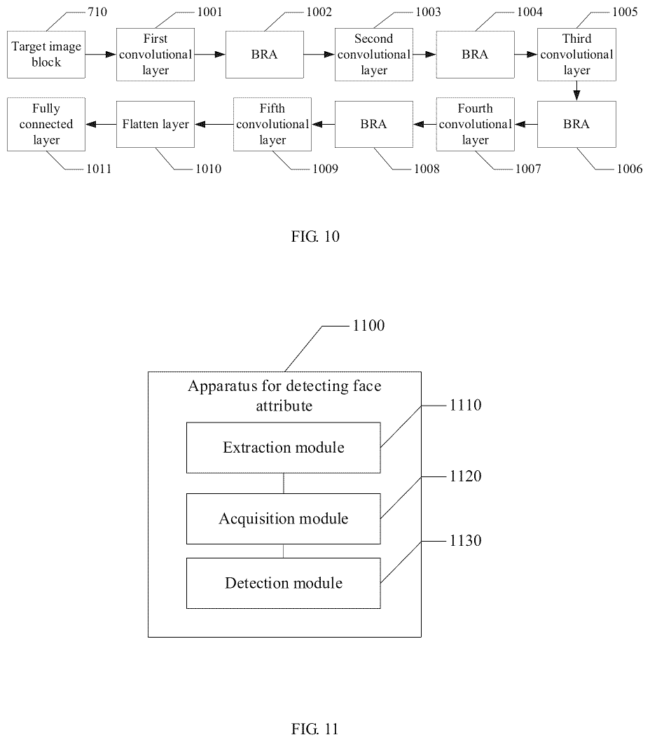

In this exemplary embodiment, as shown in FIG. 10, the pre-trained attribute detection model may include 5 convolutional layers, which are a first convolutional layer (Conv 1) 1001 having 32 convolution kernels of size 3*3, BRA 1002 (i.e., a BatchNorm layer, a Relu layer, and an AveragePooling layer) connected to the first convolutional layer 1001, a second convolutional laver (Conv 2) 1003 having a convolution kernel of size 3*3, BRA 1004 (a BatchNorm layer, a Relu layer, and an AveragePooling layer) connected to the second convolutional layer 1003, a third convolutional layer (Conv 3) 1005 having a convolution kernel of size 3*3, BRA 1006 (a BatchNorm layer, a Relu layer, and an AveragePooling layer) connected to the third convolutional layers, a fourth convolutional layer (Conv 4) 1007 having 32 convolution kernels of size 3*3, BRA 1008 (a BatchNorm layer, a Relu layer, and an AveragePooling layer) connected to the fourth convolutional layer 1007, a fifth convolutional layer (Conv 5) 1009 having a convolution kernel of size 3*3, a Flatten layer 1010, and a fully connected layer (FC) 1011 in which input is 256 dimensions and output is 2 dimensions. In this case, the detection model is a binary classification, and the network optimization can be performed through a SoftmaxWithLoss layer. Since the output of the above attribute detection is regular and needs to be just yes or no, so binary classification is used, e.g., yes or no to wearing glasses, yes or no to having a beard, etc. The SoftmaxWithLoss layer is used for performing error and gradient calculations to optimize the network. The Conv 1 (32 convolution kernels of size 3*3), Conv 2 (a convolution kernel of size 3*3), Conv 3 (a convolution kernel of size 3*3), Conv 4 (32 convolution kernels of size 3*3), and Conv 5 (a convolution kernel of size 3*3) are all used for feature extraction.

The first convolutional layer 1001 includes 32 3*3 convolutional kernels, and the first convolutional layer is connected to a ReLU layer and an Average-Pooling layer. Image of specific pixels passes through the first convolutional layer to obtain a feature image with the number corresponding to the convolutional kernels of the first convolutional layer, the ReLU layer enables part of neurons to output 0, causing sparsity, and the Average-Pooling layer compresses the feature image to extract main features. Then the feature image is fed into the second convolutional layer.

The second convolutional layer 1003 includes a 3*3 convolutional kernel, and the second convolutional layer is connected to a ReLU layer and an Average-Pooling layer. Image of specific pixels passes through the second convolutional layer to obtain a feature image with the number corresponding to the convolutional kernel of the second convolutional layer, the ReLU layer enables part of neurons to output 0, causing sparsity, and the Average-Pooling layer compresses the feature image to extract main features. Then the feature image is fed into the third convolutional layer.

The third convolutional layer 1005 includes a 3*3 convolutional kernel, and the third convolutional layer is connected to a ReLU layer and an Average-Pooling layer. Image of specific pixels passes through the third convolutional layer to obtain a feature image with the number corresponding to the convolutional kernel of the third convolutional layer, the ReLU layer enables part of neurons to output 0, causing sparsity, and the Average-Pooling layer compresses the feature image to extract main features. Then the feature image is fed into the fourth convolutional layer.

The fourth convolutional layer 1007 includes 32 3*3 convolutional kernels, and the fourth convolutional layer is connected to a ReLU layer and an Average-Pooling layer Image of specific pixels passes through the fourth convolutional layer to obtain a feature image with the number corresponding to the convolutional kernels of the fourth convolutional layer, the ReLU layer enables part of neurons to output 0, causing sparsity, and the Average-Pooling layer compresses the feature image to extract main features. Then the feature image is fed into the fifth convolutional layer.

In this exemplary embodiment, one BatchNorm layer is connected between each convolutional layer and the ReLU layer in sequence, and the ReLU layer does not change the size of the feature image. When the depth network has too many levels, the signal and gradient are smaller and smaller, and the deep layer is difficult to train, which is called gradient diffusion, and the signal and gradient are possibly larger and larger, which is called gradient explosion. The BatchNorm layer normalizes the output of the neuron to a mean of 0 and a variance of 1, and after passing through the BatchNorm layer, all neurons are normalized to a distribution.

The fifth convolutional layer 1009 includes a 3*3 convolutional kernel, and the fifth convolutional layer is connected to a Flatten layer 1010 and a fully connected layer. Specifically, the Flatten layer 1010 is used to “flatten” data input into the layer, i.e., to convert multi-dimensional data output from a previous layer into one-dimensional data. The fully connected layer 1011 serves to fully connect the features output by the convolutional layer and the features output by the connected layer, and the fully connected layer output is a 256-dimensional feature.

In this exemplary embodiment, in the training process, a. SoftmaxWithLoss layer includes a Softmax layer and a multi-dimensional LogisticLoss layer. The Softmax layer maps the former score condition to the probability of belonging to each class, and then the Softmax layer is followed by the multi-dimensional LogisticLoss layer, and the loss of the current iteration is obtained here. The combination of the Softmax layer and the multi-dimensional LogisticLoss layer into one layer ensures the stability of the value.

It should be noted that, the convolutional kernel in each of the convolutional layers may be customized according to requirements, and are not limited to the above example, where the number of convolutional layers may also be customized according to requirements and is not specifically limited in this exemplary embodiment.

In one exemplary embodiment of the present disclosure, the method for detecting the face attribute may also include integrating each piece of the target attribute information to obtain the face attribute. Specifically, a position relationship of each of the target parts on the human face, for example, the top-bottom relationship of each part on the human face, may be first acquired, and then the acquired target attribute information may be arranged according to the position relationship to obtain the face attribute.

In this exemplary embodiment, the attribute information of the target part may be arranged according to the position of the target part on the human face, so that the user can refer to the face attribute more clearly and simply according to the attribute information.

In summary, in this exemplary embodiment, the face image is first segmented, and the target image blocks of different target parts are recognized using different models. On one hand, purposeful detection of the attributes of the target part that need to be detected can avoid recognition of the face attributes which are not needed, and thus improving the detection speed; on the other hand, one attribute detection model is set for each kind of attribute information of each target part, so that the detection accuracy can be improved, on yet another hand, multiple attribute detection models can be used simultaneously and the multiple attribute detection models are small and run faster, and thus improving the face attribute detection speed.

It is to be noted that the accompanying drawings are merely illustrative description of processes included in the method according to the exemplary embodiments of the present disclosure and are not intended to limit the present disclosure. It is easy to understand that the processes shown in the accompanying drawings do not indicate or limit time sequences of these processes. Furthermore, it is also easy to understand that these processes may be executed, for example, synchronously or asynchronously in a plurality of modules.

Further, as shown in FIG. 11, in this exemplary embodiment, an apparatus for detecting face attribute 1100 is also provided, which includes an extraction module 1110, an acquisition module 1120, and a detection module 1130.

The extraction module 1110 may be configured to extract a face image from a candidate image.

The extraction module 1110 may further be configured to determine a plurality of reference key points in the face image, and determine initial coordinates of the reference key points; acquire target coordinates of the plurality of reference key points; and perform face alignment on the face image according to the target coordinates and the initial coordinates.

The acquisition module 1120 may be configured to acquire a target image block corresponding to at least one target part of the face image.

Specifically, in one exemplary embodiment, when a target image block corresponding to at least one target part of the face image is acquired, a plurality of target key points in the face image may be determined; the at least one target part in the face image may be determined according to the plurality of target key points; and the smallest area of the face image capable of containing the one of the at least one target part may be determined as the target image block.

In one exemplary embodiment, when a target image block corresponding to at least one target part of the face image is acquired, the face image may be adjusted to a preset size; in response to the face image being in the preset size, vertex coordinates of the target image block corresponding to the one of the at least one target part are acquired; and the target image block is acquired from the face image according to the vertex coordinates.

The detection module 1130 may be configured to obtain, for one of the at least one target part, target attribute information by performing attribute detection on the target image block corresponding to the target part using a pre-trained attribute detection model corresponding to the target part.

The apparatus may further include a training module. The training module is configured to: acquire a plurality of sample face images and an initial attribute detection model corresponding to each target part of the plurality of sample face images; acquire, from each one of the plurality of sample face images, at least one reference image block of the each target part and reference attribute information of the each target part; and obtain the pre-trained attribute detection model corresponding to the each target part by training the initial attribute detection model according to the reference image block and the reference attribute information corresponding to each target part.

The device may further include an adjusting module, the adjusting module may be configured to obtain the face attribute by integrating target attribute information of the at least one target part. Specifically, respective position relationships of the at least one target part on the human face may be acquired; and the face attribute may be obtained by arranging the target attribute information of the at least one target part according to the position relationships.

The specific details of each module in the apparatus have been described in detail in the method section, and details that are not disclosed may refer to the embodiment contents of the method section, and thus are not repeatedly described herein.

Further, as shown in FIG. 2, the processor of the electronic device provided in this exemplary embodiment can perform the following steps as shown in FIG. 3: step S310, extracting a face image from a candidate image; step S320, acquiring a target image block corresponding to at least one target part of the face image; and step S330, obtaining, for one of the at least one target part, target attribute information by performing attribute detection on the target image block corresponding to the target part using a pre-trained attribute detection model corresponding to the target part.

The processor 210 may further be configured to determine a plurality of reference key points in the face image, and determine initial coordinates of the plurality of reference key points; acquire target coordinates of the plurality of reference key points; and perform face alignment on the face image according to the target coordinates and the initial coordinates.

In one exemplary embodiment, the processor 210 may further be configured to acquire a target image block corresponding to at least one target part of the face image by: determining a plurality of target key points in the face image; determining the at least one target part in the face image according to the plurality of target key points; and determining the smallest area of the face image capable of containing the one of the at least one target part as the target image block.

In one exemplary embodiment, the processor 210 may further be configured to acquire a target image block corresponding to at least one target part of the face image by: adjusting the face image to a preset size; in response to the face image being in the preset size, acquiring vertex coordinates of the target image block corresponding to the one of the at least one target part; acquiring the target image block from the face image according to the the vertex coordinates.

In one exemplary embodiment, the processor 210 may further be configured to: acquire a plurality of sample face images, and an initial attribute detection model corresponding to each target part of the plurality of sample face images; acquire, from each one of the plurality of sample face image, at least one reference image block of the each target part and reference attribute information of the each target part; and obtain the pre-trained attribute detection model corresponding to the each target pail by training the initial attribute detection model according to the at least one reference image block and the reference attribute information corresponding to each target part. The processor 210 may further be configured to obtain the face attribute by integrating target attribute information of the at least one target part, specifically, the processor 210 may be further configured to acquire respective position relationships of the at least one target part on a human face; and obtain the face attribute by arranging the target attribute information of the at least one target part according to the position relationships.

As for the specific contents of the steps implemented by the processor, reference may be made to the description of the method for detecting the face attribute, which is not repeatedly described herein.

As will be appreciated by those skilled in the art, aspects of the present disclosure may be implemented as systems, methods, or program products. Accordingly, aspects of the present disclosure may be implemented specifically in following forms; an entirely hardware embodiment, an entirely software embodiment (including firmware, microcode, etc.) or an embodiment combining software and hardware aspects that may all generally be referred to as a “circuit,” a “module” or a “system” herein.

Exemplary embodiments of the present disclosure also provide a computer readable storage medium storing a program product capable of implementing the method in the specification thereon. In some possible embodiments, aspects of the present disclosure may be implemented as a form of a program product, which includes a program code. When the program product runs on the terminal device, the program code is used for enabling the terminal device to perform the steps described in the above “exemplary method” portions of the specification according to various exemplary embodiments of the present disclosure.

In this exemplary embodiment, the program product on the computer-readable storage medium, when being implemented, represents the method for detecting the face attribute, and when the program product on the computer-readable storage medium is running on a processor, the processor may implement the following steps as shown in FIG. 3: step S310, extracting a face image from a candidate image; step S320, acquiring a target image block corresponding to at least one target part of the face image; and step S330, obtaining, for one of the at least one target part, target attribute information by performing attribute detection on the target image block corresponding to the target part using a pre-trained attribute detection model corresponding to the target part.

The processor, when executing the program product on the readable storage medium, may also implement; determining a plurality of reference key points in the face image, and determining initial coordinates of the plurality of reference key points; acquiring target coordinates of the plurality of reference key points; and performing the face alignment on the face image according to the target coordinates and the initial coordinates.

In one exemplary embodiment, the processor, when executing the program product on the readable storage medium, may implement acquiring the target image block corresponding to the at least one target part of the face image by: determining a plurality of target key points in the face image; determining the at least one target part in the face image according to the plurality of target key points; and determining a smallest area of the face image capable of containing the one of the at least one target part as the target image block.

In one exemplary embodiment, the processor, when executing the program product on the readable storage medium, may implement acquiring the target image block corresponding to the at least one target part of the face image by: adjusting the face image to a preset size; acquiring, in response to the face image being in the preset size, vertex coordinates of the target image block corresponding to the one of the at least target part; and acquiring the target image block from the face image according to the vertex coordinates.

In one exemplary embodiment, the processor, when executing the program product on the readable storage medium, may also implement; acquiring a plurality of sample face images and an initial attribute detection model corresponding to each target part of the plurality of sample face images; acquiring, from each one of the plurality of sample face images, at least one reference image block of the each target part and reference attribute information of the each target part; and obtaining the pre-trained attribute detection model corresponding to the each target part by training the initial attribute detection model according to the at least one reference image block and the reference attribute information corresponding to the each target part. The processor, when executing the program product on the readable storage medium, may implement; obtaining the face attribute by integrating target attribute information of the at least one target part, specifically, the respective position relationships of the at least one target part on a human face may be acquired; and the face attribute may be obtained by arranging the target attribute information of the at least one target part according to the position relationships.

As for the specific contents of the relevant steps that can be implemented by the processor when running a program product on the readable storage medium, reference may be made to the description of the face attribute detection method, which is not repeatedly described herein.

It should be noted that, the computer-readable medium shown in present disclosure may be a computer-readable signal medium or a computer-readable storage medium or any combination thereof. The computer-readable storage medium may be for example but not limited to, an electronic, magnetic, optical, electromagnetic, infrared, or semiconductor system, apparatus, or device, or any combination thereof. More specific examples of the computer-readable storage medium may include but not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

In the present disclosure, a computer-readable storage medium may be any tangible medium that contains or stores a program that can be used by or in conjunction with an instruction execution system, apparatus, or device. In the present disclosure, the computer-readable signal medium may include a data signal that propagates in baseband or as a part of a carrier wave carrying computer-readable program code. Such a propagated data signal may take a variety of forms, including but not limited to an electromagnetic signal, an optical signal, or any suitable combination thereof. The computer-readable signal medium may also be any computer-readable medium other than a computer-readable storage medium that may send, propagate, or transmit a program for use by or in connection with an instruction execution system, apparatus, or device. Program codes included on a computer readable medium may be transmitted using any suitable medium, including but not limited to: wireless, electrical wires, optical cables, RFs, etc., or any suitable combination thereof.

Furthermore, program codes for performing the operations of the present disclosure can be written in any combination of one or more programming languages, including an object oriented programming language such as Java. C++ etc., also including conventional procedural programming language—such as the “C” language or a similar programming language. The program codes can execute entirely on a user computing device, partially on the user device, as a stand-alone software package, partially on a remote computing device and partially on the user computing device, or entirely on the remote computing device or a server. In the case of the remote computing device, the remote computing device can be connected to the user computing device through any kind of network, including a local area network (LAN) or wide area network (WAN), or can be connected to an external computing device (e.g., connected via the Internet through an Internet service provider).

After considering the specification and practicing the invention disclosed herein, other embodiments of the present disclosure will be apparent to those skilled in the art. The present application is intended to cover any variations, uses, or adaptations of the present disclosure, which follow the general principles of the present disclosure and include common general knowledge or conventional technical means in the art that are not disclosed in the present disclosure. The specification and embodiments are only considered as exemplary, and the real scope and spirit of the present disclosure is indicated by the claims.

It should be understood that the present disclosure is not limited to the precise structure that has been described above and shown in the accompanying drawings, and that various modifications and changes may be made without departing from the scope thereof. The scope of the present disclosure is limited only by the appended claims.

1. A method for detecting a face attribute, comprising:
extracting a face image from a candidate image;
acquiring a target image block corresponding to at least one target part of the face image; and
obtaining, for one of the at least one target part, target attribute information by performing attribute detection on the target image block corresponding to the target part using a pre-trained attribute detection model corresponding to the target part.

2. The method according to claim 1, wherein extracting the face image from the candidate image, comprises:
extracting the face image from the candidate image, and performing face alignment on the face image.

3. The method according to claim 2, wherein performing the face alignment on the face image, comprises:
determining a plurality of reference key points in the face image, and determining initial coordinates of the plurality of reference key points;
acquiring target coordinates of the plurality of reference key points; and
performing the face alignment on the face image according to the target coordinates and the initial coordinates.

4. The method according to claim 1, wherein acquiring the target image block corresponding to the at least one target part of the face image, comprises:
determining a plurality of target key points in the face image;
determining the at least one target part in the face image according to the plurality of target key points; and
determining a smallest area of the face image capable of containing the one of the at least one target part as the target image block.

5. The method according to claim 1, wherein acquiring the target image block corresponding to the at least one target part of the face image, comprises:
adjusting the face image to a preset size;
acquiring, in response to the face image being in the preset size, vertex coordinates of the target image block corresponding to the one of the at least target part; and
acquiring the target image block from the face image according to the vertex coordinates.

6. The method according to claim 1, further comprising:
acquiring a plurality of sample face images and an initial attribute detection model corresponding to each target part of the plurality of sample face images;
acquiring, from each one of the plurality of sample face images, at least one reference image block of the each target part and reference attribute information of the each target part; and
obtaining the pre-trained attribute detection model corresponding to the each target part by training the initial attribute detection model according to the at least one reference image block and the reference attribute information corresponding to the each target part.

7. The method according to claim 1, further comprising:
obtaining the face attribute by integrating target attribute information of the at least one target part.

8. The method according to claim 7, wherein obtaining the face attribute by integrating the target attribute information of the at least one target part, comprises:
acquiring respective position relationships of the at least one target part on a human face; and
obtaining the face attribute by arranging the target attribute information of the at least one target part according to the position relationships.

9. (canceled)

10. A non-transitory computer-readable medium, having a computer program stored thereon, wherein the computer program, when executed by a processor, implements following acts:
extracting a face image from a candidate image;
acquiring a target image block corresponding to at least one target part of the face image; and
obtaining, for one of the at least one target part, target attribute information by performing attribute detection on the target image block corresponding to the target part using a pre-trained attribute detection model corresponding to the target part.

11. An electronic device, comprising:
a processor; and
a memory for storing one or more programs, when executed by one or more processors, cause the one or more processors to implement following acts:
extracting a face image from a candidate image;
acquiring a target image block corresponding to at least one target part of the face image; and
obtaining, for one of the at least one target part, target attribute information by performing attribute detection on the target image block corresponding to the target part using a pre-trained attribute detection model corresponding to the target part.

12. The electronic device according to claim 11, wherein the processor is further configured to:
extract the face image from the candidate image, and perform face alignment on the face image.

13. The electronic device according to claim 12, wherein the processor is further configured to:
determine a plurality of reference key points in the face image, and determine initial coordinates of the plurality of reference key points;
acquire target coordinates of the plurality of reference key points; and
perform the face alignment on the face image according to the target coordinates and the initial coordinates.

14. The electronic device according to claim 11, wherein the processor is further configured to:
determine a plurality of target key points in the face image;
determine the at least one target part in the face image according to the plurality of target key points; and
determine a smallest area of the face image capable of containing the one of the at least one target part as the target image block.

15. The electronic device according to claim 11, wherein the processor is further configured to:
adjust the face image to a preset size;
acquire, in response to the face image being in the preset size, vertex coordinates of the target image block corresponding to the one of the at least target part; and
acquire the target image block from the face image according to the vertex coordinates.

16. The electronic device according to claim 11, wherein the processor is further configured to:
acquire a plurality of sample face images and an initial attribute detection model corresponding to each target part of the plurality of sample face images;
acquire, from each one of the plurality of sample face images, at least one reference image block of the each target part and reference attribute information of the each target part; and
obtain the pre-trained attribute detection model corresponding to the each target part by training the initial attribute detection model according to the at least one reference image block and the reference attribute information corresponding to the each target part.

17. The electronic device according to claim 11, wherein the processor is further configured to:
obtain the face attribute by integrating target attribute information of the at least one target part.

18. The electronic device according to claim 17, wherein the processor is further configured to:
acquire respective position relationships of the at least one target part on a human face; and
obtain the face attribute by arranging the target attribute information of the at least one target part according to the position relationships.

19. The non-transitory computer-readable medium according to claim 10, wherein the computer program, when executed by a processor, further implements:
extracting the face image from the candidate image, and performing face alignment on the face image.

20. The non-transitory computer-readable medium according to claim 19, wherein the computer program, when executed by a processor, further implements:
determining a plurality of reference key points in the face image, and determining initial coordinates of the plurality of reference key points;
acquiring target coordinates of the plurality of reference key points; and
performing the face alignment on the face image according to the target coordinates and the initial coordinates.

21. The non-transitory computer-readable medium according to claim 10, wherein the computer program, when executed by a processor, further implements:
determining a plurality of target key points in the face image;
determining the at least one target part in the face image according to the plurality of target key points; and
determining a smallest area of the face image capable of containing the one of the at least one target part as the target image block.
